(19) United States
(12) Patent Application Publication
(10) Pub. No.: US 2002/0095439 A1
(43) Pub. Date: Jul. 18, 2002

(54) METHOD OF POSITIONING DISPLAY IMAGES

(76) Inventors: TIMOTHY MERRICK LONG, LINDFIELD (AU); JULIE YAN ZHU, EPPING (AU); ALISON JOAN LENNON, BALMAIN (AU); RICHARD LAM, WATERLOO (AU)

Correspondence Address: FITZPATRICK CELLA HARPER & SCINTO, 30 ROCKEFELLER PLAZA, NEW YORK, NY, 10112, US

(21) Appl. No.: 09/026,614

(22) Filed: Feb. 20, 1998

(30) Foreign Application Priority Data
Feb. 20, 1997 (AU) P05233

(51) Int. Cl. G06F 15/00

(52) U.S. Cl. 707/507

(57) ABSTRACT

A method of arranging a plurality of images on a page includes the step of arranging the images on the page in accordance with a first predetermined layout pattern. The images are then rearranged in accordance with a “controlled overlapping” rule characterized by a predetermined cost function. Finally, the predetermined cost function is optimized to determine a final coordinate position for each image, thereby to generate a final layout pattern.

### FIELD OF THE INVENTION

The present invention relates to the display of digital images and, in particular, to the automatic arrangement of digital images to produce a visually pleasing result.

### BACKGROUND ART

Electronic photo-albums have become increasingly popular in recent times. These electronic photo-albums typically take the form of a collection of images stored using a non-volatile memory device, from which a user can retrieve the image for displaying on a display device. Usually, the images are gathered in digital form, and may, for example, be scanned by an electronic scanner, down-loaded from the internet or produced by a digital camera. A collection of these images can be stored electronically to create an electronic photo-album, analogous to the traditional family photo-album which uses photographic prints.

Presently, electronic photo-albums take the form of a collection of images, a user of the album being able to associate a caption or brief description with each image. For example, a user can collect a series of family photographs of a wedding, whether from a digital video or still camera, and associate a caption such as the date and a brief description of the event with each image. If desired, an electronic photo-album can be reproduced from the memory device by a high quality output device, such as a high resolution colour printer, to produce an album substantially similar to a conventional photo-album.

Electronic photo-albums do not generally provide an efficient manner of arranging images in a visually pleasing arrangement, as users must typically arrange each image manually on a page.

It is an object of the invention to overcome, or at least ameliorate, one or more of the disadvantages of the prior art.

### SUMMARY OF THE INVENTION

Accordingly, in a first aspect, there is provided a computer implemented method of arranging a plurality of images on a page, the method including the steps of:

arranging the images on the page in accordance with a first predetermined layout pattern; and

rearranging the images in accordance with a predetermined set of arrangement rules, thereby to generate a final layout pattern for the images on the page.

wherein the first predetermined layout pattern is selected at random from a set of predetermined layout patterns.

Preferably, the predetermined set of arrangement rules includes one or more of the following rules:

a) a “non-printable area” rule;

b) a “controlled overlapping” rule;

c) a “vertical space distribution” rule;

d) a “horizontal space distribution” rule;

e) an “edge alignment” rule;

f) an “adjacent edges rule”; and

g) a “centre attraction” rule.

In a preferred embodiment, the first predetermined layout pattern is selected at random from a set of predetermined layout patterns.

In a second aspect, there is provided a method of arranging a plurality of images in an image-album including at least one page, the method including the steps of:

arranging the images on the page in accordance with a first predetermined layout pattern; and

rearranging the images in accordance with a predetermined set of arrangement rules, each of the arrangement rules being characterised by a predetermined cost function;

optimising the predetermined cost function for each rule to determine a final coordinate position for each image, thereby to generate a final layout pattern.

Preferably, the final layout position of each image on a page of the image provides an aesthetically pleasing arrangement of the plurality of images.

### BRIEF DESCRIPTION OF THE DRAWINGS

Embodiments of the present invention will now be described with reference to the drawings, in which:

FIG. 1 shows an examples of first predetermined layout patterns for arranging up to three images on a page, in accordance with the invention;

FIG. 2 shows further examples of first predetermined layout patterns for arranging up to three images on a page, in accordance with the invention;

FIG. 3 is a block diagram of a general purpose computer upon which the various embodiments of the present invention can be implemented;

FIG. 4 shows an example of a layout area according to the invention;

FIG. 5 illustrates two examples of image overlap according to the invention;

FIG. 6 is a schematic diagram showing an example of a white space well according to the invention;

FIG. 7 is a diagram showing an example of alignment of alike edges of an image according to the invention;

FIG. 8 is a diagram showing an example of centre attraction of images according to the invention.

FIG. 9 is a flowchart illustrating the basic steps of a method of positioning display images;

FIG. 10 is a detailed flowchart showing more detailed steps associated with the method shown in FIG. 9; and

FIG. 11 is a flowchart illustrating steps involved in implementing a cost function according to the invention.

### DETAILED DESCRIPTION

Referring to the drawings, the invention includes two main stages.

A first stage, referred to below as an “initial seed stage”, includes the step of arranging the images on the page in accordance with a first predetermined layout pattern.

A second stage, referred to below as an “adjust layout stage”, involves rearranging the images in accordance with a predetermined set of arrangement rules. By rearranging the initial layout in this way, there is generated a final layout position for the images which produces an aesthetically pleasing result with minimal input from the user.

Preferably, the images are initially positioned within a predetermined layout area where it is desirable to place an image. This layout area may be determined or selected on the basis of, for example, display or viewing issues, or margins for printing and binding.

The predetermined layout pattern can form part of a specific template, or may be selected as part of application software running on a computer system. A further option is that the predetermined pattern is randomly selected, by a computer system, from a specified set of patterns.

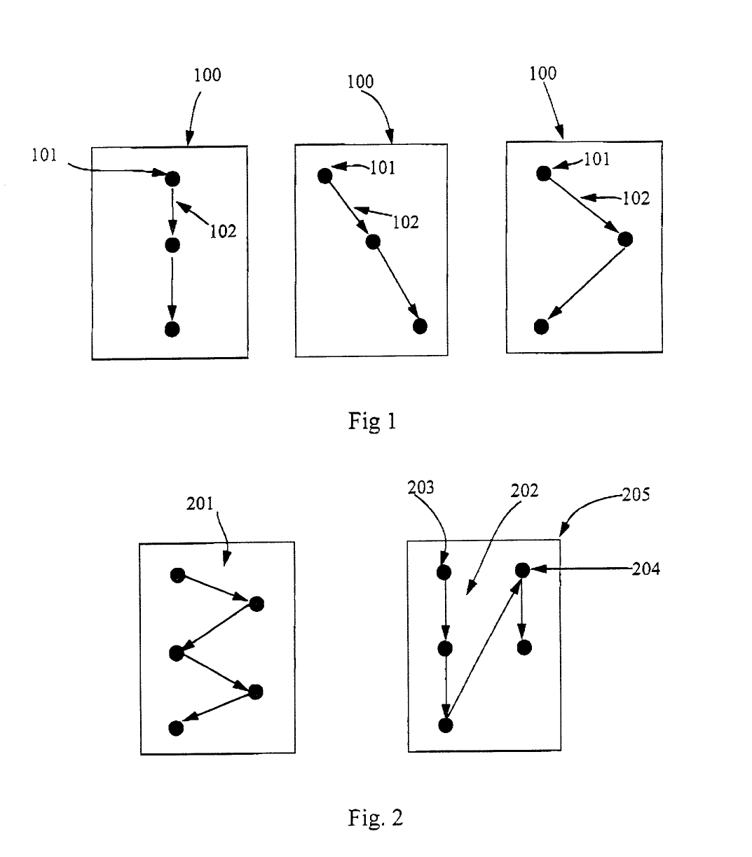

The predetermined layout pattern which is selected, or provided by a template. dictates an initial arrangement and flow of images onto an electronic page. For example, illustrated in FIG. 1 are three predetermined layout patterns for arranging images onto a page 100. A dot 101 indicates a position where an image is to be placed in accordance with the selected pattern, whilst an arrow 102 indicates a typical flow to a next image position of the pattern.

The patterns shown in FIG. 1 may be used for up to three images per page. However, the initial seed stage is not limited to this number of positions or images, as shown in the examples of predetermined layout patterns illustrated in FIG. 2. One example of FIG. 2 illustrates a horizontal zigzag pattern arrangement 201 for image positioning, whilst the other example shows a vertical zigzag arrangement 202. The vertical zigzag pattern arrangement 202 shows the image positions (dots) arranged in a first column 203 and a second column 204. However, the number of columns used may be altered depending upon the width of the page involved, and the widths of the images themselves.

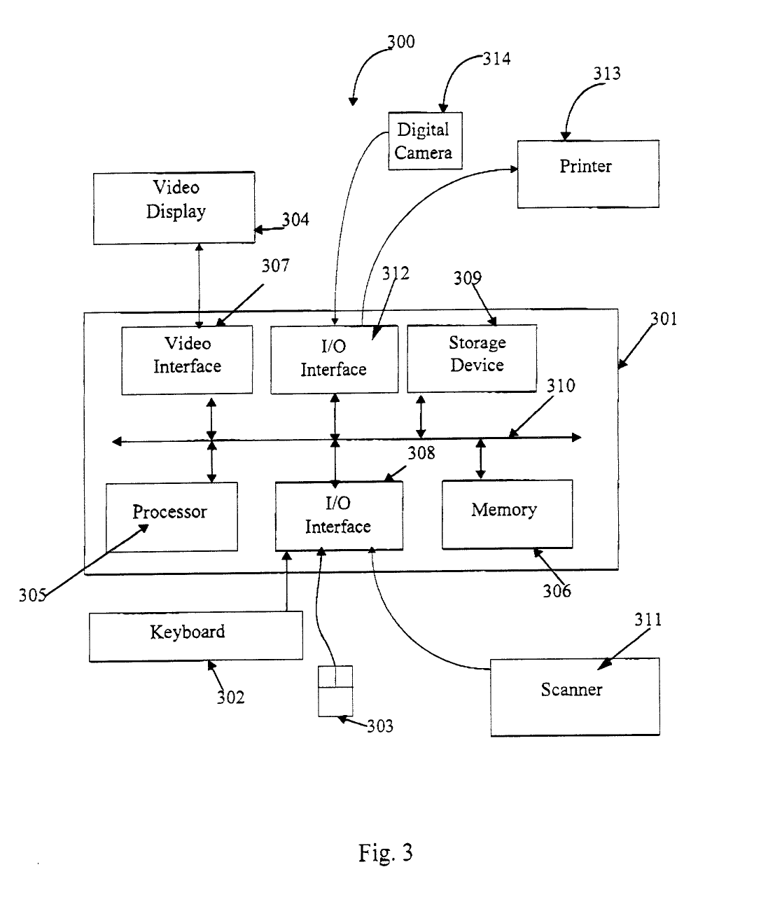

Turning to FIG. 3, in a preferred form, the invention may be implemented on a conventional general-purpose computer system 300. The various steps of the invention are implemented by software executed by the computer system 300.

The computer system 300 includes a computer 301, input devices 302., 303 and a display device 304. There is also provided at least one processor unit 305, a memory unit 306 which typically includes random access memory (RAM) and read only memory (ROM), and input/output (I/O) interfaces, including a video interface 307, interface 308 for a keyboard 302, a digital scanner device 311 and mouse 303 or other control device. The storage device 309 can include a floppy disk, a hard disk drive, a CD-ROM drive or similar non-volatile storage device known to those skilled in the art. Further, the general-purpose computer can have additional I/O interfaces 312 for such peripheral devices as a printer 313 and a non-digital video or still camera 314 for downloading images to the computer. The components 305 to 309 of the computer 301 typically communicate via an interconnected bus 310, and in a manner which results in a usual mode of operation of the computer system 300 known to those skilled in the relevant art. Examples of computers on which the embodiments can be practised include IBM-PC/ATs and compatibles, and Sun Sparcstations or the like.

The “adjust layout” stage rearranges the images from the predetermined layout pattern, according to a predetermined set of rules. The following are examples of the types of rules which might be applied during the “adjust layout” stage:

1) Non Printable Area Rule: acts to constrain images within a predetermined layout area, as described above.

2) Controlled Overlapping Rule: provides no overlapping on a page, or at least minimising the amount of overlapping required for a given set of images. However, if it is desired that the images overlap, the Controlled Overlapping Rule may be employed to control the style and amount of overlapping for each image.

3) Vertical Space Distribution Rule: balances (or evens out) space distribution surrounding images in a vertical direction. Often, unprinted or unused space on a page surrounding an image is referred to as “white space”, and the Vertical Space Distribution Rule attempts to balance the white space above and below an image.

4) Horizontal Space Distribution Rule: substantially similar to the Vertical Space Distribution Rule, but acts in a horizontal direction.

5) Edge Alignment Rule: aligns alike edges of images that fall within a predetermined range threshold position both horizontally and vertically.

6) Adjacent Edges Rule: keeps adjacent edges of images on a page a predetermined. minimum or maximum distance apart.

7) Centre Attraction Rule: positions an image on a predetermined central line of the layout area.

A more detailed description of each of these rules is provided below,

The various rules are not rigidly satisfied for adjusting a layout of the image on a page. In some cases, this would not be possible, as the application of different rules may result in mutually opposing requirements in terms of image placement. In the preferred embodiment where these problems are sought to be overcome, the various rules are satisfied in a proportional manner to achieve an optimum compromise that provides a desired result.

An optimum compromise is achieved by assigning to each of the above rules a component cost function. Each of these functions will return a penalty cost if the rule is not satisfied, and no penalty cost if the rule is satisfied precisely. A generalised cost component function, preferably, takes on a form shown in Equation 1, set out below:

cost=F(x₁, y₁, x₂, y₂, . . . , xₙ, yₙ) (EQ 1)

where x₁, y₁ are the coordinates of a geometric of an “ith” image on a page comprising n images.

An example of this is rule 1) above, which has a component cost function associated with it. The cost function returns, for example, a zero cost value if the area of all images to be arranged falls within all boundaries of the layout area, and returns a positive maximum cost value if the area of the image falls entirely outside the layout area. The cost function returns an intermediate proportional cost value, between zero and the positive maximum cost value, if only a portion of the area of the image falls outside the layout area.

In the preferred form, an objective function is used to optimise all of the above rules simultaneously. An objective function is a weighted sum of the individual component cost functions set out for each rule. Minimising a value returned by the objective function achieves an optimum compromise of the above rules and hence an optimum compromise of a desired positioning of the images on a page.

For r-number of predetermined image positioning rules, an objective function can be expressed mathematically as:

$$Objective - Cost = {\sum }_{i = 1}^{r} \{ {W}_{i} {F}_{i} ( {x}_{1} , {y}_{1} , {x}_{2} , {y}_{2} , … , {x}_{n} , {y}_{n} ) \} \qquad ( EQ 2 )$$

where Wᵢ is a weight function (or value) associated with a cost component function Fᵢ for an “ith” rule of r-number of rules.

A weight function associated with a cost component function provides a weighting and hence a priority associated with a corresponding rule. For example, if it is desired that the Non Printable Area rule be satisfied over the Controlled Overlapping rule, that is if images should preferably fall within the layout area at the cost of overlapping the images, then a greater weight function (or value) is assigned to cost component function associated with the Non Printable Area rule than that assigned to the weight function associated with the Controlled Overlapping rule.

An optimisation technique is applied to the objective function to obtain, for the present example, a minimum value for the objective function. The optimisation technique determines a set of desired coordinate positions for each image on a page.

Preferably, the coordinate positions indicate where a geometric centre of an image is to be placed on a page. The preferred optimization technique for the present embodiment is known as the Downhill Simplex method. However, other techniques are available for optimising one or more functions, such as “Powell's Method” (including Direction Set Methods) or simulated annealing.

A more detailed description of each of the above rules will now be provided.

Non Printable Area

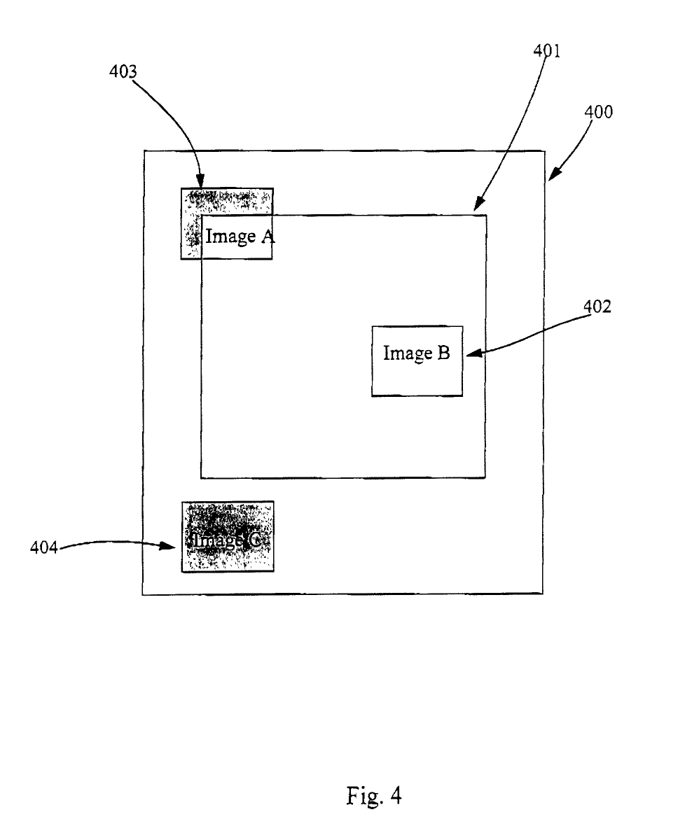

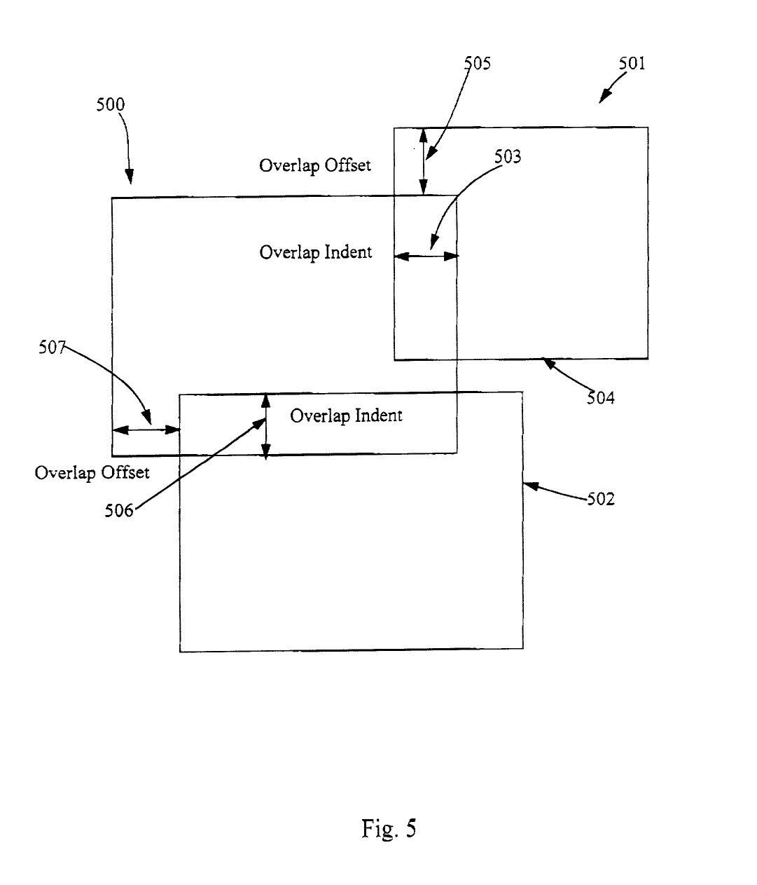

The Non Printable area rule attempts to constrain images within a predetermined layout area. A cost component function associated with the Non Printable Area rule is determined, preferably, as a sum of areas of images (or portions thereof) falling outside a predetermined layout area, normalised with respect to a total area of the images to be arranged on the page. FIG. 4 illustrates an electronic page 400, having a predetermined layout area 401 within which it is desired to have the images fall. Generally, at the initial seed stage, images are placed on a page according to a predetermined pattern and therefore the images do not necessarily fall within the layout area 401. In the example of FIG. 4, a first image (image A) 403 falls partially outside (shaded area of item 403 in FIG. 4) the layout area 401, a second image (image B) 402 falls within the layout area 401 and a third image (image C) 404 falls entirely outside the layout area 401. A significant cost penalty, determined by the cost component function, is associated the layout of the images of FIG. 4, since a significant portion (shaded area of image A and all of image C) of a total image area falls outside the layout area 401.

Preferably a large weight function (or value) is associated with a cost component function for the Non Printable area rule as it is desirable that this rule be satisfied at the expense of the other rules.

Controlled Overlapping

At the initial seed stage of the preferred embodiment, images are arranged without necessarily determining their sizes or any potential overlaps. Consequently, images initially positioned on a page may overlap each other. A cost component function associated with the Controlled Overlapping rule acts to determine a set of coordinates for the positioning of images on a page that minimises an overlapping of the images and, preferably, provides no overlapping of the images. Optionally, where an overlapping of images is desired, the Controlled Overlapping rule attempts to implement overlapping of two or more images in an acceptable or desirable manner. In a preferred embodiment the Controlled Overlapping Rule can operate in either of the two modes described above.

The first mode is a Reduce Overlapping Mode—in this mode an overlapping between images is minimised to preferably produce no overlapping. A cost component function associated with the present option of the Controlled Overlapping rule is determined as a total overlap area normalised with respect to a total area of images on a page. Upon minimising the cost component function associated with the present option a set of coordinates for a positioning of the images on a page is evaluated.

The second mode is a Use Overlapping Mode—in this mode overlapping of images by a predetermined overlap amount is preferred. The predetermined overlap amount is preferably, achieved by using an Overlap Indent Parameter (OIP) and an Overlap Offset Parameter (OOP).

The OIP specifies an amount (or portion) of overlaying between a pair of images, where preferably the OIP is a predetermined percentage length of a side of one image of the pair of images. The OOP represents an offset distance between a pair of overlapping images, where the OOP is determined, preferably, as a percentage of a side of one of the images.

Illustrated in FIG. 5 are three rectangles representing three images overlapped using the Use Overlapping mode option. A first image 500 is partly overlapped by a second image 501 and also partly overlapped by a third image 502. An OIP value 503 between the first image 500 and the second image 502 is determined as a percentage of a side 504 of the smallest size image between the first 500 and second image 501. An OOP value 505 determines an amount of offset in an overlap between the first image 500 and the second image 501. Similarly, an OIP value 506 and an OOP value 507 is determined for an overlap between the first image 500 and the third image 502.

A cost component function for the Use Overlapping rule is based upon an OIP and an OOP value for each image pair. A cost penalty is incurred for a pair of images not overlapped by a predetermined OIP value and a predetermined OOP value. Accordingly, the cost component function is a minimum when a pair of images overlap substantially by an amount given by the predetermined OIP and the predetermined OOP.

Vertical and Horizontal Space Distribution

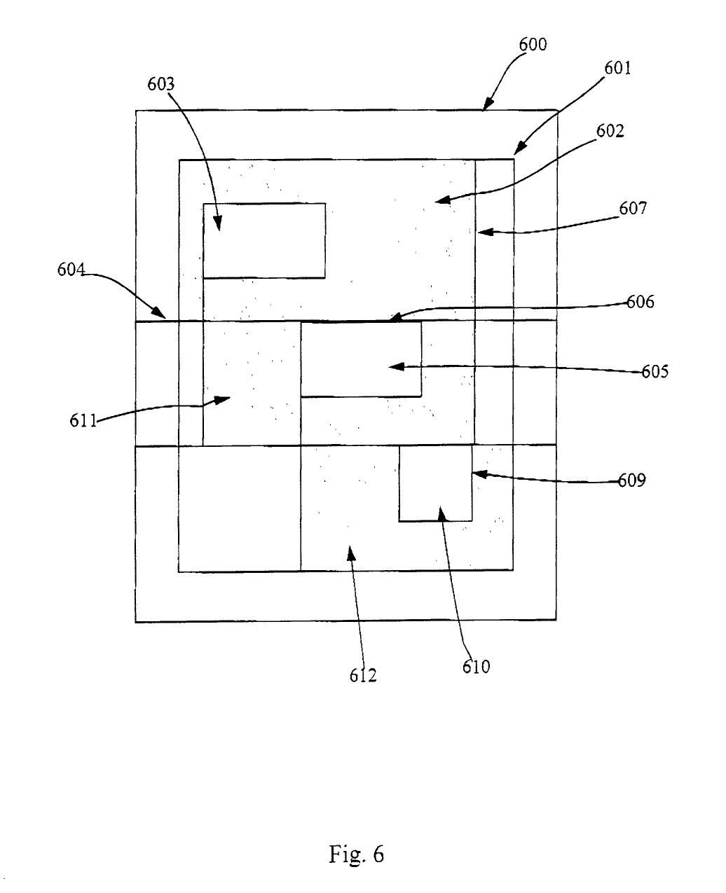

The vertical and horizontal space distribution rules attempt to uniformly distribute “white space” surrounding an image with a predetermined boundary area referred to herein as a “white space well”. Preferably, the boundaries of the white space well are defined by a layout area of a page and by a relative position of other images on the page. For example, FIG. 6 illustrates an electronic page 600 having a layout area defined thereon. Three images are positioned on the page 600 at an initial seed stage in accordance with one of the predetermined patterns illustrated in FIG. 1. A first white space well 602 is shown for a first image 603 where: the well is bounded above and the to left of the first image by boundaries of the layout area; the well is bounded below by a horizontal line boundary 604 co-linear with an edge 606 of a second image 605, and a vertical line boundary 607 co-linear with an edge 609 of a third image 610. Similarly, a second white space well 611 is defined for a second image 605 and a third white space well 612 is defined for a third image 610.

In the example of FIG. 6, the size of a white space well is defined by a relative positioning of the images on the page 600 and by the layout area 601. However, it will be appreciated by those skilled in the art that a white space well can be defined, modified or changed without departing from the scope and spirit of the present invention. For example, a white space well can be predetermined based on the size (dimensions) of an image and a predetermined arrangement on a page.

Having defined a white space well for an image, a cost component function is determined on the basis that the image is geometrically to be centred within the white space well. Hence, a large cost component function value is associated with an image not centred in its corresponding white space well and a minimal cost is associated with an image which is geometrically centred within its white space well. Minimising (optimising) a cost component function for the Vertical and Horizontal Space Distribution rule provides a set of coordinates for the placement of images on a page which, preferably, best distributes the white space around an image.

Edge Alignment

A cost component function associated with the Edge Alignment rule returns a cost associated with misaligned edges of a plurality of images placed on a page. The cost associated of the misalignment of edges depends on the magnitude of the misalignment. The edge alignment rule attempts to align alike edges of two or more images. Alike edges of two images are corresponding edges of the two images. For example, for two images placed side by side, a top edge of each image, a left edge of each image, a right edge of each image and a bottom edge of each image are referred to herein as alike edges. If the magnitude of the misalignment of alike edges of a pair of images is relatively small, then it is desirable to “attract” the alike edges towards a predetermined alignment boundary. However, if the misalignment exceeds a predetermined critical threshold distance then it is desirable to “repel” the alike edges away from a possible aligned position.

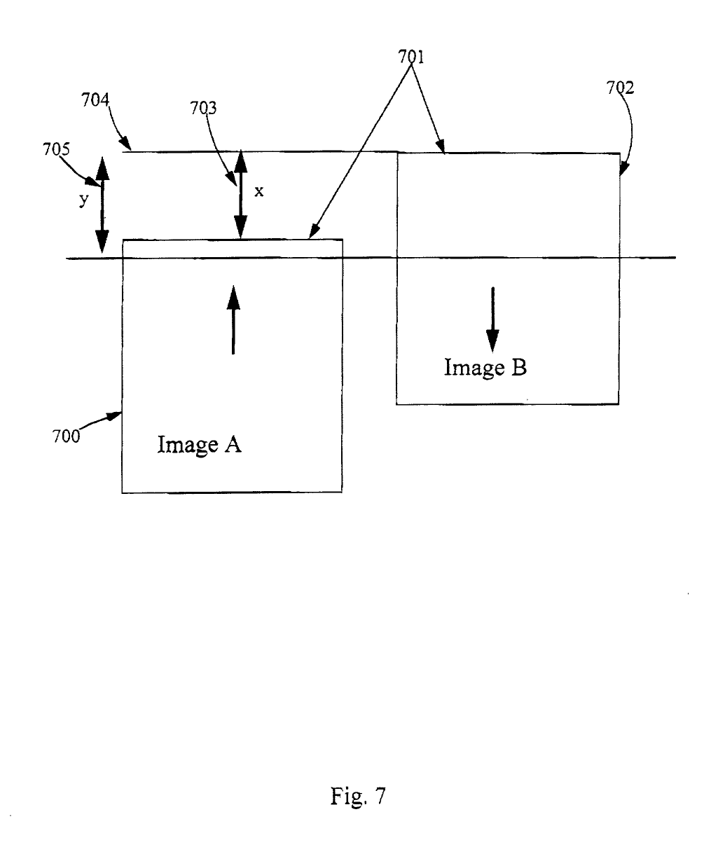

FIG. 7 illustrated a pair of images to which the Edge Alignment rule is applied to horizontal alike edges. A first image 700 of the pair has an edge 701 with the corresponding alike edge of a second image 702 misaligned. A magnitude of the misalignment is determined by a distance ‘x’ 703 from a predetermined alignment boundary 704. A predetermined critical threshold distance ‘y’ 705 is preferably defined such that if the magnitude of the misalignment distance ‘x’ 703 is less than or equal to the predetermined critical threshold distance ‘y’ 705 then the alike edges 701 are attracted towards the predetermined alignment boundary 704. Otherwise, the alike edges are repel such that the magnitude of the misalignment distance ‘x’ 703 is maximised.

In an implementation according to the preferred embodiment of the edge alignment rule, a cost component function returns a high cost value when the misalignment distance ‘x’ 703 is equal to the predetermined critical threshold distance ‘y’ 705, but decreases as the misalignment distance ‘x’ 703 is made smaller or greater than the threshold distance ‘y’ 705.

Preferably, the cost component function for the edge alignment rule takes the form of a quadratic function for a misalignment distance ‘x’ less than or equal to a predetermined critical threshold distance ‘y’, substantially similar to:

$$Cost = A [ 1 - {( \frac{y - x}{y} )}^{2} ] ( for x < y ( attractor ) ) \qquad ( EQ 3 )$$

and an exponential decay function a form substantially similar to:

Cost=A exp(−k(x−y)) (for y<x(repeller)) (EQ 4)

The constant value ‘A’ in EQ3 and EQ4 is preferably normalised for each pair of images to a maximum value of one (1.0).

Alignment of vertical alike edges of a pair of images can be described substantially as the alignment of horizontal alike edges of a pair of images referred to previously with reference to FIG. 7. The edge alignment rule is preferably applied to both horizontal and vertical alike edges of a pair of images.

Adjacent Edges

A cost component function, associated with the Adjacent Edges rule, returns a cost value on the bases that a pair of images are too close or touching each other.

In the implementation of the preferred embodiment, the cost component function for the present rule is implemented using an exponential decay model with a function substantially similar to EQ 4. The cost component function returns a maximum cost value associated with touching edges of a pair of images, the cost value decreasing as the edges of a pair of images are moved apart.

Centre Attraction

A cost component function associated with the centre attraction rule returns a cost value based on an amount of off-centreing of an image with respect to a predetermined horizontal or vertical centre axis of a page or layout area. In the preferred embodiment, a centre-line critical distance is defined as a predetermined percentage value of a height or width of a layout area. An off-centre distance, between a geometric centre of an image and a predetermined vertical (or horizontal) centre axis of a page, is determined for each image on a page. If the off-centre distance is less than or equal to the centre-line critical distance, the geometric centre of the image is attracted towards the predetermined vertical (or horizontal) centre axis. Otherwise, the geometric centre of the image is repelled away from the predetermined vertical (or horizontal) centre axis.

Preferably the cost component function, for the present rule, returns a maximum cost value when the off-centre distance is equal to the centre-line critical distance for an image on a page and the cost value decreases rapidly as the off-centre distance progressively decreases. The cost value decreases exponentially (in a similar manner to that shown in EQ4) for off-centre distances greater than the centre-line critical distance.

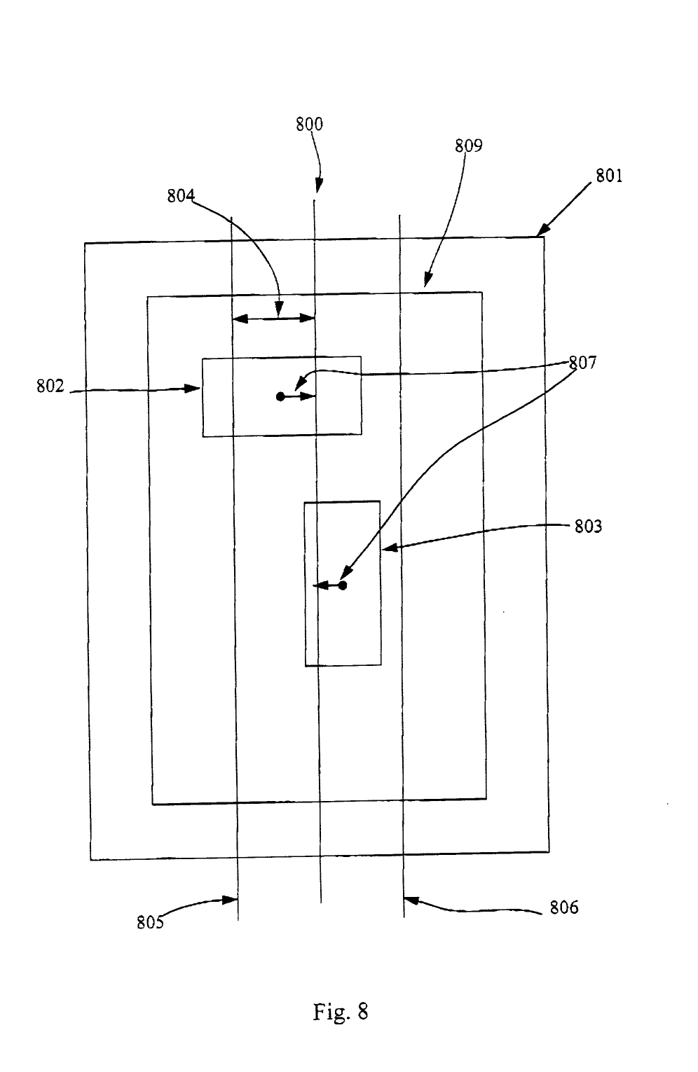

Illustrated in FIG. 8 are two images slightly off-centre with respect to a predetermined vertical centre axis 800 of a page 801. A first image 802 is off-centre to the left of a centre axis 800 and a second image 803 is off-centre to the right. A centre-line critical distance 804 is determined as a specified percentage of a width of a layout area 509. In the example illustrated by FIG. 8, the centre-line critical distance 804 about the vertical centre axis is marked by dotted lines 805 and 806. An off-centre distance 807 is determined for each image on the page 801 as a shortest distance between a geometric centre of each image to the vertical centre axis 800.

In the example shown in FIG. 8, the off-centre distance 807 of each image is less than the centre-line critical distance for each image, and therefore a minimisation of the cost component function results in a geometric centre for each image preferably moving (being “attracted”) towards the predetermined vertical centre axis 800 of a page 801.

In the preferred embodiment of the present invention, cost component functions for substantially all the above rules are solved simultaneously to provide a set of coordinate values for a positioning each image on a page. One technique has been described herein, where a cost component function for each rule is appropriately weighted and an objective function is constructed and optimised to provide a set of coordinate positions for each image which provide an optimal compromise between all of the rules.

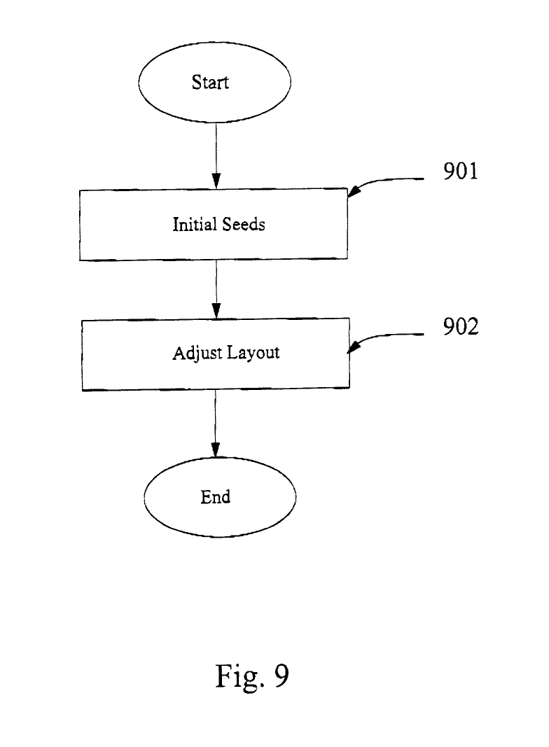

FIG. 9 shows a basic flowchart for implementing the invention in its simplest form. At step 901, the initial seeds are set out, meaning that images are placed upon the page in accordance with a first predetermined layout pattern. This predetermined layout pattern is then adjusted (902) with reference to a number of predetermined rules.

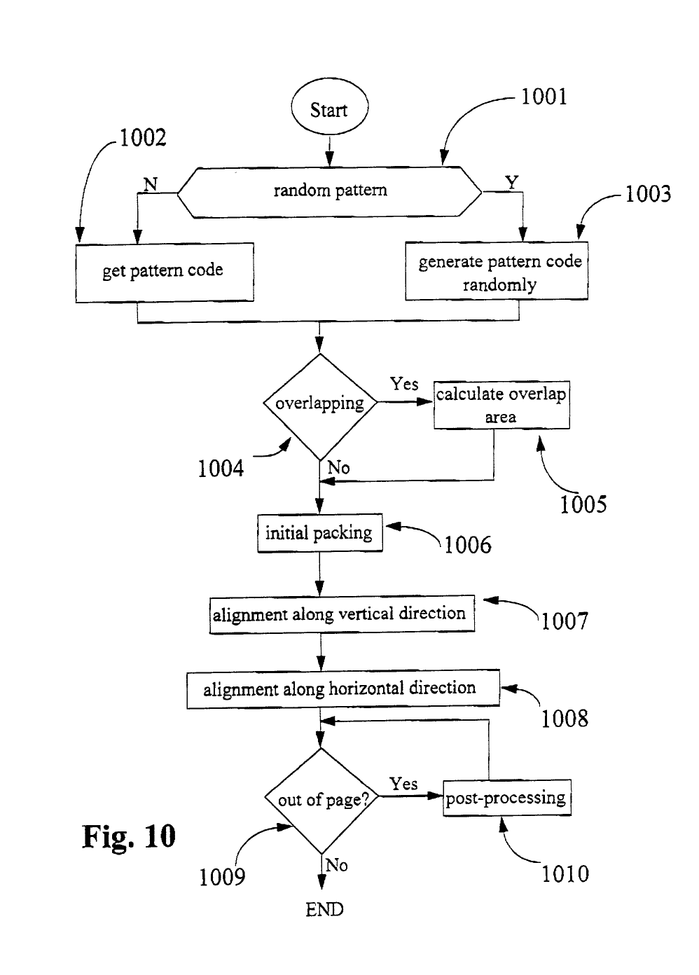

Turning to FIG. 10, which shows a preferred implementation of the method shown in FIG. 9, a decision (1001) is made as to whether a random initial seed pattern is required. If not, a pattern code is obtained (1002) and used to generate an initial predetermined layout pattern for the images. If necessary, a random initial seed pattern is generated (1003) and used as the basis for initial arrangement of the images.

If overlap is detected (1004), the overlap area is calculated (1005), whilst if no overlap is detected, the initial packing step (1006) is undertaken.

Following this, the images are aligned along the vertical direction (1007) and then aligned along the horizontal direction (1008).

The final step is to check (1009) whether the resultant arrangement has caused the images to spill out of the page or layout area. If this is the case, further processing (1010) takes place until the images no longer spill from the page or layout area.

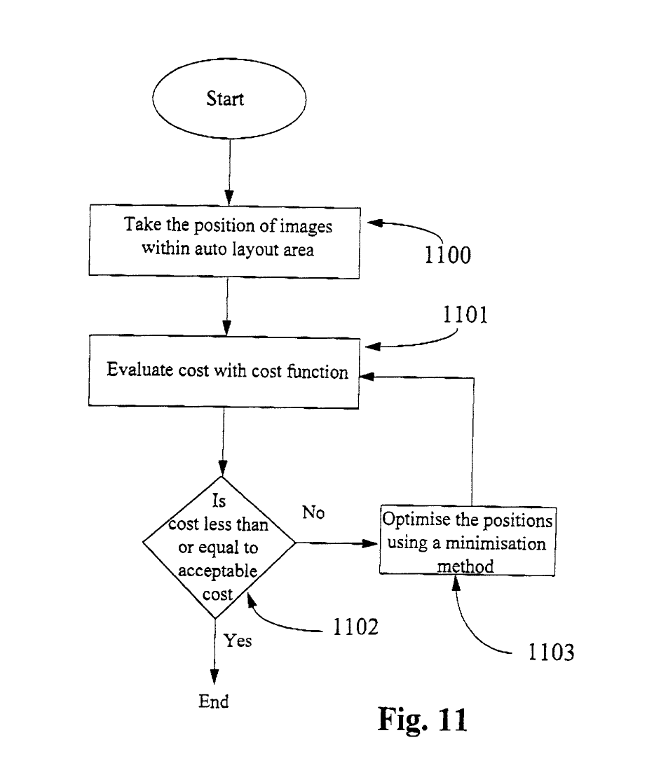

Turning to FIG. 11, the position of the images within the layout area are taken (1100), and then evaluated (1101) with a cost function, as has been described in detail above. An assessment (1102) is then made as to whether the resultant cost calculated by the cost function falls within an acceptable range. As discussed above, this will usually be a question of whether the cost falls below a certain acceptable cost. If the cost falls within the required range, the process is finished, and the images may be rendered to a display screen or a printer. However, if the cost falls outside of the required range, it is necessary to further optimise (1103) the positions of the image using a suitable minimisation method, such as any of those described earlier.

In another embodiment, the above rules and steps may be applied to the arrangement of sets or families of images on a page. A family or set comprises a collection of one or more page items that link together such that the position of each item in the Family Group is relative to another page item of the group. A page item may consist of a text slot comprising text characters, an image slot comprising one or more digital images including object-based images, a clipart slot comprising computer generated images, or a family group itself comprising one or more page items. For example, a user may wish to produce an electronic photo-album of a relative's wedding. In this album the user can choose to: construct a family group by linking several images together according to a predetermined preference (eg. relating to the church scene); link captions and/or clipart to one or more of the selected images and generate several family groups; or link one or more family groups together.

In the present embodiment substantially all the rules applied to an image of the preferred embodiment are also applicable to a family group of image.

After the layout procedure is completed, the page (and any others which have been produced) may be printed to produce a hardcopy of the electronic photo-album analogous to the well known “photographic album”. This printing may take place on any suitable printer, which is preferably a high quality colour printer such as BJC 610 Colour Bubble Jet printer manufactured by Canon).

While the invention has been described with reference to an electronic photo-album, the method may be adapted for use in other electronic documents. For example, the invention may be applied to documents produced by word processor or “desk-top publishing” software. Furthermore, the electronic photo-album or the predetermined layout area need not be displayed on a display device in a “what-you-see-is-what-you-get” (WYSIWIG) manner. There may be provided, for example, a simplified, block-based view, or the arrangement may simply not be viewed until completed or even printed, However WYSIWYG is a preferred display option.

The foregoing only describes only a number of embodiments of the present invention, however, modifications and/or changes can be made thereto by a person skilled in the relevant art without departing from the scope and spirit of the invention.

1. A computer implemented method of arranging a plurality of images on a page, said method comprising the steps of:
providing an initial layout position, wherein the plurality of images are arranged on the page in accordance with a predetermined pattern position; and
adjusting the initial layout position in accordance with a predetermined set of rules to provide a final layout position for the images to produce an aesthetically pleasing result.

2. A method as recited in claim 1, wherein the predetermined pattern position is selected at random from a plurality of predetermined pattern positions.

3. A method as recited in claim 1, wherein the predetermined set of rules include one or more of the following rules:
a) Non Printable Area Rule;
b) Controlled Overlapping Rule;
c) Vertical Space Distribution Rule;
d) Horizontal Space Distribution Rule;
e) Edge Alignment Rule;
f) Adjacent Edges Rule; and
g) Centre Attraction Rule.

4. A method as recited in claim 1 or claim 3, wherein the predetermined set of rules are provided each with a specific cost function.

5. A method as recited in claim 4, wherein the step of adjusting the initial layout position further includes constructing an objective cost function based on one or more of said specific cost functions and minimising (optimising) the objective cost function to provide a set of co-ordinate positions for each image of the final layout position.

6. A method as recited in claim 5, wherein minimising the objective cost function includes applying a simplex method or a direction set method technique.

7 A method as recited in claim 5, wherein minimising the objective cost function includes applying a simulated annealing technique.

8. A method of arranging a plurality of images in an image-album, the image-album consisting of at least one page, said method comprising the steps of:
providing an initial layout position, wherein the plurality of images are arranged on the page in accordance with a predetermined pattern position;
providing a predetermined set of rules for refining the initial layout position to a final layout position, wherein each rule is characterised by a predetermined cost function; and
evaluating (minimising) said predetermined cost function, for each rule, to provide a coordinate position of each image of the final layout position.

9. A method as recited in claim 8, wherein final layout position of each image on a page of the image provides an aesthetically pleasing arrangement of the plurality of images.

10. A method as recited in claim 1 or claim 8, wherein a position of an image for the predetermined pattern position is selected randomly.

11. A method of arranging a plurality of images on a page, the method including the steps of:
arranging the images on the page in accordance with a first predetermined layout pattern;
rearranging the images in accordance with a “controlled overlapping” rule characterised by a predetermined cost function;
optimising the predetermined cost function to determine a final coordinate position for each image, thereby to generate a final layout pattern.

12. A method according to claim 11, wherein optimisation of the predetermined cost function includes minimising a result of that function.

13. A method according to claim 11, wherein optimisation of the cost function results in no overlap of the images with respect to each other.

14. A method according to claim 11, wherein optimisation of the cost function results in minimisation of overlap of all the images with respect to each other.

15. A method according to claim 11, wherein optimisation of the cost function results in a preselected overlap of the images with respect to each other.

16. A method according to claim 11, wherein optimisation of the cost function results in minimisation of a difference between a preselected overlap and the actual overlap of all the images with respect to each other.

17. A method according to any one of claim 11, wherein the amount of overlap is defined in terms of an Overlap Indent Parameter (OIP), the OIP being expressed as a proportion of a side of one of the overlapping images.

18 A method according to claim 17, wherein the cost function is a function of an Overlap Offset Parameter (OOP), the OOP representing an offset distance between between a pair of the overlapping images.

19. A method according to claim 18, wherein the OOP is expressed as a proportion of a side of one of the overlapping images.

20. A method according to claim 18, wherein the cost function is optimised when the overlapping images overlap by an amount given by the predetermined OIP and OOP parameters.

21. A method according to claim 11, wherein the optimisation of the cost function is performed by a predetermined minimisation algorithm.

22. A method according to claim 21, wherein the predetermined minimisation algorithm is based on a downhill simplex method

23. An apparatus for arranging images on a page in accordance with the method of claim 11.

24. A computer readable medium comprising instructions adapted to implement the method of claim 11.

25. A computer implemented method of arranging a plurality of images on a page, the method including the steps of:
arranging the images on the page in accordance with a first predetermined layout pattern, and
rearranging the images in accordance with a predetermined set of arrangement rules, thereby to generate a final layout pattern for the images on the page.

26. A method according to claim 25, wherein the first predetermined layout pattern is selected at random from a set of predetermined layout patterns.

27. A method according to claim 25, wherein the predetermined set of arrangement rules includes one or more of the following rules:
a) a “non-printable area” rule;
b) a “controlled overlapping” rule;
c) a “vertical space distribution” rule;
d) a “horizontal space distribution” rule;
e) an “edge alignment” rule;
f) an “adjacent edges rule”; and
g) a “centre attraction” rule.

28. A method according to claim 25, wherein each of the arrangement rules in the set of arrangement rules is provided with an individual cost function.

29. A method according to claim 28, wherein the rearrangement step includes the sub-steps of:
constructing an objective cost function based on one or more of the individual cost functions; and
optimising the objective cost function to determine a set of final positions for each image, thereby to generate the final layout pattern.

30. A method according to claim 29, wherein the sub-step of optimising the objective cost function includes applying a simplex method or a direction set method technique.

31. A method according to claim 29, wherein the sub-step of optimising the objective cost function includes applying a simulated annealing technique.

32. A method of arranging a plurality of images in an image-album including at least one page, the method including the steps of:
arranging the images on the page in accordance with a first predetermined layout pattern;
rearranging the images in accordance with a predetermined set of arrangement rules, each of the arrangement rules being characterised by a predetermined cost function; and
optimising the predetermined cost function for each rule to determine a final coordinate position for each image, thereby to generate a final layout pattern.

33. A method according to claim 32, wherein the final layout position of each image on a page of the image provides an aesthetically pleasing arrangement of the plurality of images.

34. A method according to claim 32 or claim 33, wherein a position of an image for the first predetermined layout pattern is selected randomly from a set of predetermined layout patterns.

35. An apparatus for arranging images on a page in accordance with the method of claim 25.

36. An apparatus for arranging a plurality of images on a page, the apparatus including:
means configured to arrange the images on the page in accordance with a first predetermined layout pattern;
means configured to arrange the images in accordance with a “controlled overlapping” rule characterised by a predetermined cost function;
optimisation means configured to optimise the predetermined cost function to determine a final coordinate position for each image, thereby to generate a final layout pattern.

37. An apparatus according to claim 36, wherein the optimisation means are configured such that optimisation of the predetermined cost function includes minimising a result of that function.

38. An apparatus according to claim 36, wherein the optimisation means are configured such that optimisation of the cost function results in no overlap of the images with respect to each other.

39. An apparatus according to claim 36, wherein the optimisation means are configured such that the cost function results in minimisation of overlap of all the images with respect to each other.

40. An apparatus according to claim 36, wherein the optimisation means are configured such that optimisation of the cost function results in a preselected overlap of the images with respect to each other.

41. An apparatus according to claim 36, wherein the optimisation means are configured such that optimisation of the cost function results in minimisation of a difference between a preselected overlap and the actual overlap of all the images with respect to each other.

42. An apparatus according to claim 36, wherein the amount of overlap is defined in terms of an Overlap Indent Parameter (OIP), the OIP being expressed as a proportion of a side of one of the overlapping images.

43. An apparatus according to claim 42, wherein the cost function is a function of an Overlap Offset Parameter (OOP), the OOP representing an offset distance between between a pair of the overlapping images.

44. An apparatus according to claim 43, wherein the OOP is expressed as a proportion of a side of one of the overlapping images.

45. An apparatus according to claim 43, wherein the cost function is optimised when the overlapping images overlap by an amount given by the predetermined OIP and OOP parameters.

46. A computer readable medium comprising instructions adapted to implement the method of claim 25 or claim 34.
